(19) United States
(12) Patent Application Publication
(10) Pub. No.: US 2024/0169231 A1
(43) Pub. Date: May 23, 2024

(54) ADAPTIVE LEARNING FOR QUANTUM CIRCUITS

(71) Applicant: Quantum Computing Inc., Leesburg, VA (US)

(72) Inventors: Raouf DRIDI, Leesburg, VA (US); Uchenna CHUKWU, Leesburg, VA (US); Touheed Anwar ATIF, Leesburg, VA (US)

(21) Appl. No.: 18/055,319

(22) Filed: Nov. 14, 2022

(51) Int. Cl. G06N 10/20; G06N 3/0985

(52) U.S. Cl. CPC G06N 10/20; G06N 3/0985

(57) ABSTRACT

A method includes executing a quantum circuit to determine a first quantum circuit output and a gradient based on a set of input parameters. The method includes providing the quantum circuit with an updated set of input parameters to determine a second quantum circuit output, where the updated set of input parameters is determined based on the gradient and the set of input parameters. The method further includes determining a comparison value based on a learning rate parameter, the first quantum circuit output, and the second quantum circuit output and updating the learning rate parameter such that the comparison value satisfies a threshold. The method further includes updating parameters of the plurality of quantum logic gates based on the updated learning rate parameter.

### BACKGROUND

In the context of quantum computing, a quantum logic gate is a quantum computing analog of classical logic gates. In contrast to a classical computing gate that manipulates a classical bit that is limited to being in one of two states, a quantum logic gate may manipulate the state of a quantum bit (“qubit”) capable of being in a superposition of two different states. Quantum logic gate model systems constructed from quantum logic gates may take advantage of qubit properties such as superposition, entanglement, and reversibility for significant computing advantages. These properties enable significant performance increases for certain computational tasks, such as prime factorization, certain types of simulation, or certain types of optimization problems. These properties can augment or replace deep learning processes used in classical computing, where quantum circuits may provide significant advantages over conventional neural networks in various machine learning applications.

### SUMMARY

Computing systems may use gate-model quantum processors to solve optimization problems. A set of gate-model quantum processors may provide significant performance advantages over classical computing methods by taking advantage of a qubit's superposition, entanglement, or other properties. Hybrid computing systems that combine quantum and classical computing components may apply these advantages to deep learning operations when implementing a quantum circuit that performs analogously to a classical neural network. However, despite the theoretical advantages of a gate-model quantum computer, obstacles, such as decoherence, may reduce the effectiveness of a quantum circuit. Without accounting for these limitations or other limitations, quantum circuits may provide inaccurate results.

Some embodiments may address these complexities by adaptively updating a learning rate step size that may improve convergence rate and decrease the usage rate of a quantum processor. Some embodiments may first select or otherwise determine a set of quantum logic gates, forming a quantum circuit based on an initial cost function. For example, some embodiments may select a quantum circuit based on initial quadratic unconstrained binary optimization (QUBO) function. Some embodiments may then provide the quantum circuit with a set of input parameters and execute the quantum circuit using a set of quantum processors to determine a set of quantum circuit cost function outputs during iteration of the quantum circuit.

Some embodiments may update a learning rate step size based on a current set of quantum circuit cost function outputs and a new predictive set of quantum circuit cost function outputs. The current quantum circuit cost function output may be obtained by providing a quantum circuit with a current set of input parameters, and the new predictive quantum circuit cost function output may be obtained when providing the quantum circuit with an updated set of input parameters, where the updated set of input parameters is determined based on a learning rate, gradient and the current set of input parameters. Some embodiments may determine a gradient based on the current set of input parameters (used to determine the current quantum circuit cost function output). Some embodiments may determine a threshold based on the gradient and a comparison value based on a learning rate hyperparameter (e.g., a learning rate step size or another parameter correlated with the learning rate step size). Some embodiments may determine that a learning rate is sufficient and should not be reduced when the threshold is satisfied by the comparison value. When the threshold is not satisfied, some embodiments may modify the learning rate hyperparameter to a new learning rate hyperparameter such that the threshold is satisfied. Some embodiments may then update a set of gate parameters or other input parameters of a quantum circuit based on the updated learning rate hyperparameter.

Various other aspects, features, and advantages of the invention will be apparent through the detailed description of the invention and the drawings attached hereto. It is also to be understood that both the foregoing general description and the following detailed description are examples, and not restrictive of the scope of the invention.

### BRIEF DESCRIPTION OF THE DRAWINGS

FIG. 1 shows an example computing system including a classical processor and a quantum processor, in accordance with one or more embodiments.

FIG. 2 shows a conceptual diagram of a quantum neural network model, in accordance with one or more embodiments.

FIG. 3 shows a flowchart for adaptively determining a learning rate hyperparameter, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art, that the embodiments of the invention may be practiced without these specific details or with an equivalent arrangement. In other cases, well-known structures and devices are shown in block diagram form in order to avoid unnecessarily obscuring the embodiments of the invention. Furthermore, as should be understood in this disclosure, a statement that a first item is being used to determine a second item does not preclude other items from being used in conjunction with the first item to determine the second item.

Quantum circuits are models for a type of quantum computing that may be implemented by configuring a quantum computer. A quantum circuit is constructed from a set of quantum logic gates and may be selected, constructed, or otherwise determined based on a cost function or another type of input function. In some embodiments, these quantum circuits may be arranged to form networks of quantum logic gates that may operate with certain similarities to classical neural networks. These quantum circuits acting as neural networks (“quantum neural networks”) may be configured to provide solutions that are optimized with respect to a cost function. However, the advantages of quantum computing are coupled with additional complexities, such as decoherence, where such complexities have no classical computing analog. These quantum-related complexities may reduce the quality of an optimization operation that can be performed by a quantum processing unit.

Some embodiments may first determine a gradient for a cost function based on a set of parameters used to determine a quantum circuit cost function output and then use the gradient to determine a learning rate step size used for quantum circuit optimization. For example, some embodiments may construct a quantum circuit batch, based on the parameter-shift rule, where the quantum circuit batch may correspond with the derivative of the cost function with respect to each input parameter. Some embodiments may then evaluate each circuit computing the derivative of the cost function and then determine the gradient using the set of derivatives.

Some embodiments may use a quantum circuit to compute a cost function, where an output of the quantum circuit is a cost function output. Some embodiments may perform operations to reduce the number of steps required to determine an optimal solution using a quantum circuit. Such operations may include determining a quantum neural network or other type of quantum circuit based on a quadratic unconstrained binary optimization (QUBO) function, another type of binary optimization function, or another type of cost function. Some embodiments may then execute the quantum neural network or other type of quantum circuit to determine a quantum circuit cost function output. Some embodiments may determine a first quantum circuit cost function output by providing the quantum circuit with a set of input parameters and determine a second quantum circuit by providing the quantum circuit with a gradient-updated set of input parameters (i.e., “gradient-updated set of input parameters”). The gradient-updated set of input parameters may be determined based on the first set of input parameters and a gradient determined from the first set of input parameters, where the second set of input parameters may be described as a gradient-updated set of input parameters of the first set of input parameters. Based on a predicted difference associated with the difference between a first quantum neural network output determined with a first set of input parameters and a second quantum circuit cost function output determined from a gradient-updated set of input of the first set of input parameters, some embodiments may determine a learning rate hyperparameter (which may also be referred to as “learning rate parameter” in this disclosure) or other quantum circuit parameter based on the predicted difference. Some embodiments may then use this learning rate hyperparameter to perform a next set of optimization operations with the updated learning rate hyperparameter. By updating a learning rate hyperparameter when using a quantum neural network to perform an optimization operation, some embodiments may increase the improvement of a convergence rate of a quantum circuit for a given number of state advancements of the quantum circuit.

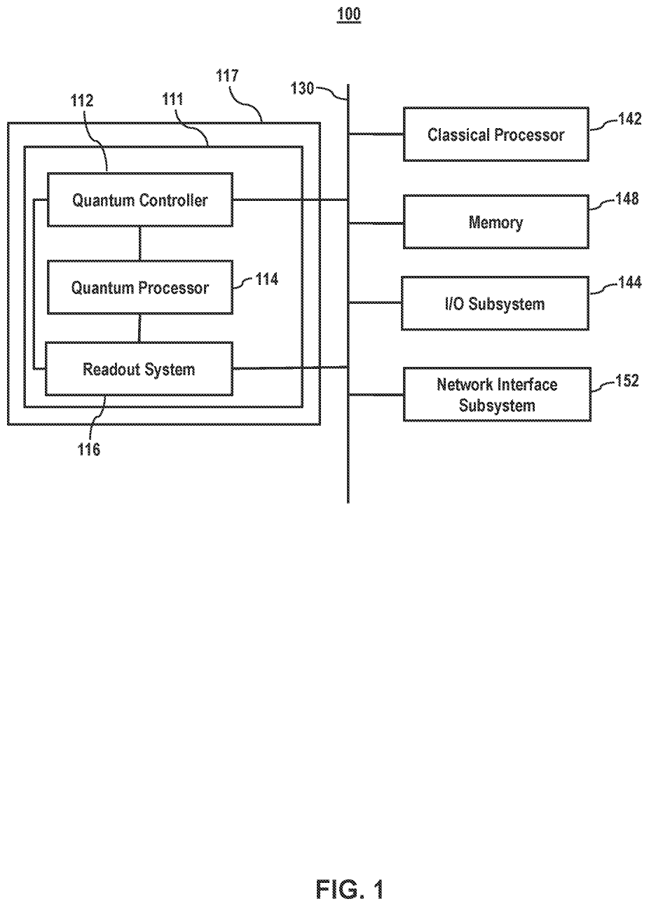

FIG. 1 shows an example computing system 100 including a classical processor and a quantum processor, in accordance with one or more embodiments. The example computing system 100 includes a classical processor 142 that may be used to perform classical processing operations described in this disclosure. For example, the classical processor 142 may perform operations to initiate an optimization operation, set the parameters of the optimization operation, provide an objective output for optimization purposes, etc. In some embodiments, the classical processor 142 may perform operations to communicate optimization parameters to a quantum system 111. The quantum system 111 may include a quantum controller 112, a quantum processor 114, and a readout system 116. For example, some embodiments may receive a set of values from an oracle via a network interface 152 and communicate the set of values to the quantum processor 114.

Some embodiments may use the classical processor 142 to execute a set of operations described in this disclosure, such as obtaining inputs or computing outputs to be communicated via the input/output (I/O) subsystem 144, retrieving or storing values in a memory 148, or obtaining values or outputting values via the network interface 152. The classical processor 142 may include various types of logic processing units, such as a processing unit with one or more central processing units (“CPUs”), graphics processing units (“GPUs”), digital signal processors (“DSPs”), application-specific integrated circuits (“ASICs”), field-programmable gate arrays (“FPGAs”), etc. The classical processor 142 may be used in various types of computing devices, such as desktop computers, laptop computers, mobile computing devices, distributed computing devices, mainframe computing devices, etc.

In some embodiments, the computing system 100 may store or transmit data via a communications link connected with the network interface 152 or another data transmission medium. Various communications links may be used, e.g., the Internet, a local area network, a wide area network, another type of wired connection, a wireless network link, etc. Thus, computer-readable media can include computer-readable storage media such as non-transitory media and computer-readable transmission media. Furthermore, some embodiments may control a quantum system 111 by sending messages to the quantum controller 112 via a system interconnect 130. Alternatively, or in addition, some embodiments may control a quantum computing device by sending messages over a network, such as by sending messages over a network interface to control the quantum computing device.

In some embodiments, a cooling system 117 may isolate the quantum controller 112 or the quantum processor 114 from an external environment. Such isolation may protect a set of qubits of the quantum processor 114 or other elements of the quantum processor 114 from external magnetic fields, electric fields, heat, noise, vibrations, or other perturbations that may add or remove energy from the quantum processor 114. The quantum processor 114 may include programmable elements such as qubits, couplers, etc., and may be configured to implement and execute a variational quantum circuit that may behave as a quantum neural network.

In some embodiments, the classical processor 142 may determine an initial set of parameters and a quantum circuit. The quantum processor 114 may then implement the quantum circuit and execute the quantum circuit based on the initial set of parameters. For example, the quantum processor 114 may execute operations to determine a quantum computing output based on an implemented quantum circuit. Some embodiments may then use the quantum processor 114 or the classical processor 142 to determine a new set of gate parameters using a gradient-based method, where the gradient-based method may include a hybrid-based method. The gradient-based method may include a method based on the parameter-shift rule, where some embodiments may use circuits to compute quantum outputs of partial gradients around perturbed parameter points and then use classical processing to formulate vectors of the respective partial gradients. Methods based on the parameter-shift rule may include a quantum natural gradient (QNG) method (i.e., a Riemann geometry descent), a stochastic approximation (SPSA), etc. A gradient-based method may include other methods, such as a stochastic gradient descent method (i.e., a Euclidean gradient descent), a finite difference method, etc. Some embodiments may use a gradient-free method, such as a simultaneous perturbation. Furthermore, the classical processor 142 may perform operations to increase the efficiency of a gradient-based method, such as performing a line search method to update a learning rate hyperparameter. The classical processor 142 may then determine an updated set of gate parameters and communicate the updated set of gate parameters to the quantum system 111. The quantum system 111 may execute the quantum circuit based on the updated set of gate parameters.

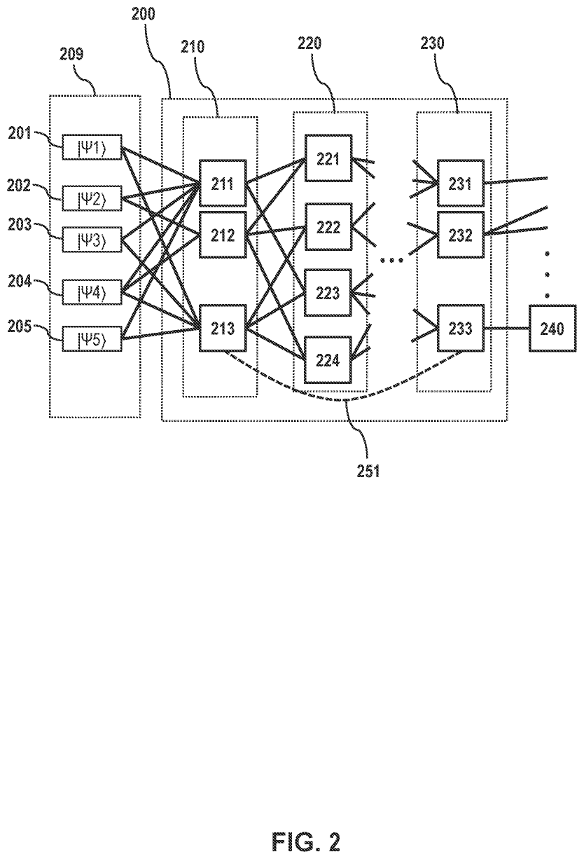

FIG. 2 shows a conceptual diagram of a quantum neural network model, in accordance with one or more embodiments. The quantum circuit 200 is a model representation of a quantum neural network, where some embodiments may use a quantum processor such as the quantum processor 114 to execute the quantum neural network. The set of inputs 209 includes inputs 201-205 and may represent an input state, such as an input state representing a set of quantum computing inputs. For example, the set of inputs 209 may represent an initial guess for a state. Alternatively, the set of inputs 209 may include a set of outputs provided by the quantum circuit 200 after an iteration of executing the quantum circuit 200.

Some embodiments may provide a set of inputs 209 to the quantum circuit 200, where the different layers of the quantum circuit 200 may be used to compute outputs that are then provided as inputs to subsequent layers of the quantum circuit 200. The quantum circuit 200 may include multiple layers, such as a first layer 210 that may serve as an input layer to receive the set of inputs 209. The quantum circuit 200 may include additional layers of quantum logic gates, such as a second layer 220 and a third layer 230. For example, the first layer 210 may receive the set of inputs 209 and determine outputs based on the set of inputs 209. The first layer 210 may then provide the outputs of the first layer 210 as inputs to the second layer 220. The second layer 220 may then provide outputs that are then used as inputs for subsequent layers of the quantum circuit 200. The quantum circuit 200 may also include the third layer 230, where an output of the third layer 230 may include a measurement represented by a box 240, and where the third layer 230 is not the adjacent layer to the second layer 220. It should be understood that, while the box 240 may include a single measurement, the box 240 may represent multiple measurements in other embodiments.

The first layer 210 includes quantum logic gates 211-213, the second layer 220 includes quantum logic gates 221-224, and the third layer 230 includes quantum logic gates 231-233. While not shown, the quantum circuit 200 may include additional quantum logic gates. In some embodiments, some or all of the logic gates of the quantum circuit 200 may be implementations of unitary operators. For example, the quantum logic gate 211 may be an implementation of a unitary operator such as a rotation operator. Furthermore, while the quantum circuit 200 depicts at least three layers, other quantum circuits may include a different number of layers. For example, another quantum circuit may include one layer, two layers, four layers, more than four layers, more than five layers, or some other number of layers.

While the quantum circuit 200 is depicted with a specific sequence of layers, other types of architecture are possible for other quantum circuits. For example, while the quantum circuit 200 may be constructed without skip connections, some embodiments may provide skip connections between different quantum logic gates. A skip connection may permit an output of a layer to be used as an input for a quantum logic gate of a non-consecutive layer. For example, some embodiments may connect the quantum logic gate 213 and the quantum logic gate 233 such that an output of the quantum logic gate 213 may be an input for the quantum logic gate 233, where this connection may be represented by the dashed line 251.

The quantum circuit 200 may be configured such that a quantum logic gate may receive each state value of a state as an input. For example, a quantum logic gate 211 may be provided with each input of inputs 201-205, where each input of the inputs 201-205 may represent a state value. Furthermore, the quantum circuit 200 may be configured such that another quantum logic gate may receive a subset of state values as inputs. For example, a quantum logic gate 212 may receive only the input 202 and the input 204, and a quantum logic gate 213 may receive only the input 201, the input 203, the input 204, and the input 205 for determining an output. While the quantum circuit 200 includes quantum logic gates that differ with respect to the number or type of inputs, some embodiments may use quantum circuits having quantum logic gates such that each gate of the quantum circuit is provided with every state value of a state. For example, if a state is characterized by 30 state values, some embodiments may provide each value of the 30 state values to each quantum logic gate of an input layer of a quantum circuit.

As described elsewhere in this disclosure, outputs of a quantum logic gate may be used as inputs for another quantum logic gate. The quantum circuit 200 may be configured such that outputs of a quantum logic gate in one layer are not provided to all of the quantum logic gates in another layer. For example, the output of a quantum logic gate 211 is provided as inputs to a quantum logic gate 221 and a quantum logic gate 223 without being provided as an input to a quantum logic gate 222 or a quantum logic gate 224. Similarly, some embodiments may provide the quantum logic gate 212 with the input 202 and the input 204 to generate an output that is used as an input by the quantum logic gates 221-222 and the quantum logic gate 224. Additionally, some embodiments may provide the quantum logic gate 213 with the input 201, the input 203, and the input 205 to determine an output that is used as an input by the quantum logic gates 222-224.

Some or all of the quantum logic gates of the quantum circuit 200 may be configured by updating the respective gate parameter(s) of the quantum logic gates of the quantum circuit 200. For example, the quantum logic gate 211 may perform a rotation transformation such that the extent of the rotation is controlled by a gate parameter of the quantum logic gate 211. The quantum circuit 200 may include various other types of operators acting as quantum logic gates, such as a Hadamard gate, a qubit NOT gate, a phase shift gate that shifts the phase of a quantum state, a controlled NOT gate that flips a bit within a state if the state satisfies a set of criteria (e.g., if the state is “|11 [symbol] ”), quantum logic gates implemented as tensor products of other quantum logic gates, etc.

As described elsewhere in this disclosure, the quantum circuit 200 may provide a quantum circuit cost function output represented by the box 240. The quantum circuit cost function output may be determined based on a plurality of other outputs, such as a sample of a plurality of other outputs of the quantum circuit or a measure of central tendency determined from the plurality of other outputs. During an optimization operation, some embodiments may determine a difference between a first quantum circuit cost function output determined based on the set of inputs 209 and a second quantum circuit cost function output determined based on the set of inputs 209 and gradient value based on the set of inputs 209. For example, some embodiments may obtain a set of strings, where the set of strings is associated with a set of labels that may be used as objectives that are then used to determine a cost function output. Some embodiments may then initiate an optimization operation based on the set of strings by providing a set of state values representing the strings to the quantum circuit 200 to determine the quantum circuit cost function output represented by the box 240.

Some embodiments may implement a gradient descent operation to modify the gate parameters of the quantum circuit 200. When implementing the gradient descent operation, some embodiments may compute a predicted difference based on a difference between a first quantum circuit cost function output determined with the set of inputs 209 and a second quantum circuit cost function output determined with a gradient-updated input of the set of inputs 209. For example, some embodiments may set the predicted difference as being equal to the value of the difference between the first quantum circuit cost function output and the second quantum circuit cost function output. In some embodiments, the magnitude of the predicted difference is correlated with an increase in the magnitude of the updates to the set of gate parameters. For example, some embodiments may modify gate parameters of the quantum circuit 200 to minimize a quantum circuit cost function based on the predicted difference.

In some embodiments, a gradient descent operation may include a quantum natural gradient (QNG) operation. For example, some embodiments may compute a Fubini-Study metric based on the quantum logic gates of the quantum circuit 200 for parameterizing the gate parameters of the quantum circuit 200. Some embodiments may then use the Fubini-Study metric to determine a gradient in the gate parameter space based on estimated likelihoods in a parameter distribution space, where the Fubini-Study metric may be determined using a set of quantum circuits, where the set of quantum circuits used to compute a Fubini-Study metric may be different is deduced or otherwise derived from the set of quantum circuits used to determine predicted differences. Some embodiments may then update the set of gate parameters based on the gradient and a learning rate hyperparameter. Alternatively, some embodiments may perform other types of gradient descent operations, such as a Euclidean gradient descent operation.

Conventional quantum circuits may be limited with respect to the efficiency or accuracy of learning operations due to quantum decoherence. Some embodiments may increase the efficiency of quantum circuits by using a line search method to increase the efficiency of learning operations between two iterations of an execution of a quantum circuit. For example, some embodiments may apply an Armijo's rule method by determining whether a learning rate parameter satisfies Armijo's rule with respect to the gate parameters. Some embodiments may then update the learning rate parameter in response to a determination that the learning rate parameter does not satisfy Armijo's rule and use the updated learning rate parameter to modify the gate parameters between two iterations of executions of a quantum circuit when optimizing the quantum circuit 200. Furthermore, while some embodiments may use a set of criteria based on Armijo's rule, some embodiments may use other methods, such as another line search threshold or a geometric threshold.

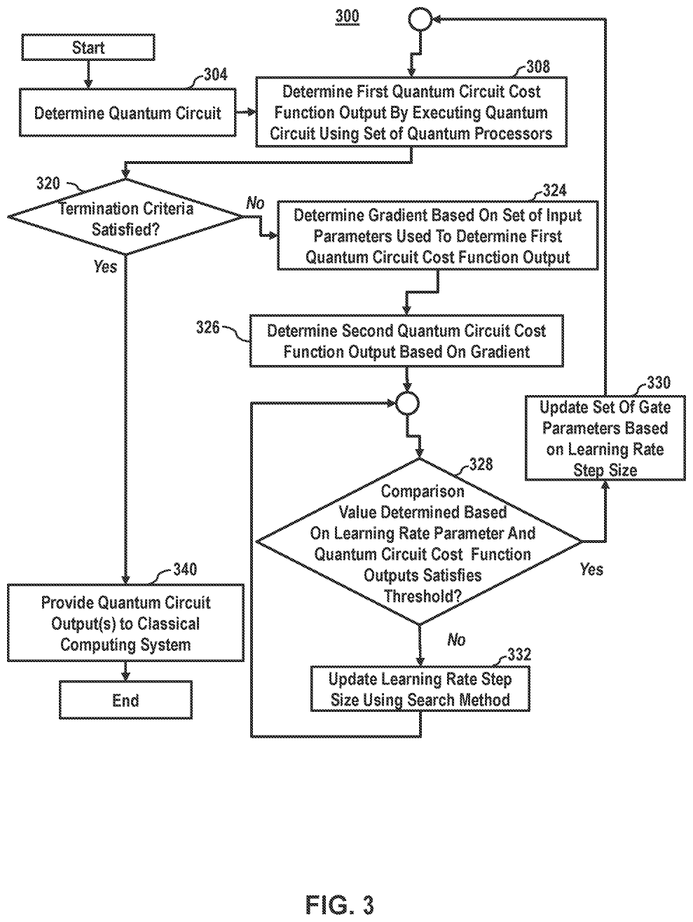

FIG. 3 shows a flowchart for adaptively determining a learning rate parameter, in accordance with one or more embodiments. Some embodiments may determine a quantum circuit, as indicated by block 304. Some embodiments may determine quantum circuit based on a set of pre-determined rules for the quantum circuit. Alternatively, some embodiments may determine a quantum circuit based on a cost function. The cost function may be a QUBO function or another type of cost function. The QUBO or other type of cost function may be obtained as a set of numeric values representing weights, as a string representing the cost function, as a record that includes a set of fields representing parameters of the cost function, or as another set of values characterizing a cost function. For example, some embodiments may obtain a QUBO function in the form of a set of numeric values representing constants of the QUBO function. In addition to determining a quantum circuit derived from a cost function, some embodiments may use a quantum circuit as an ansatz representing an architecture of the quantum circuit.

Some embodiments may use automated operations to convert an optimization problem such that the converted optimization problem may be better suited for quantum computing operations. For example, some embodiments may convert a first physical model into a QUBO function before using the QUBO function as a cost function for optimizing a quantum circuit. A computing system may implement various strategies when converting a first model into a QUBO model. For example, some embodiments may determine a set of quadratic penalties for the objective function of an optimization problem and combine the set of quadratic penalties with the objective function to determine a QUBO function. Alternatively, or in addition, some embodiments may partition an initial optimization problem into different subsets of a domain space, where different QUBO functions are applicable to the different subsets in their respective regions of the domain space.

Some embodiments may convert a cost function used to optimize a quantum neural network into a set of Hamiltonian representations of the cost function. Alternatively, some embodiments may directly retrieve a set of Hamiltonian representations. For example, some embodiments may import a file containing a set of values representing a Hamiltonian, where the set of values may include linear combinations of operators. Some embodiments may receive parameters or script instructions from a user that cause a computing device to implement a set of quantum logic gates for each input of the state, where different quantum logic gates may receive only one input or multiple inputs of a state of an optimization problem. For example, some embodiments may receive a user-provided script that causes a computing device to implement a set of quantum logic gates as rotation operators. Alternatively, or in addition, some embodiments may execute program instructions that cause a computer device to select a pre-determined quantum circuit based on an input Hamiltonian or another set of input parameters and one or more categories associated with the input. For example, some embodiments may select a quantum circuit associated with a category in response to receiving a QUBO that is labeled with the category.

Some embodiments may determine a first quantum circuit cost function output by executing a quantum circuit using a set of quantum processors, as indicated by block 308. Some embodiments may execute a quantum circuit by providing the quantum circuit with an initial guess state and then executing quantum logic gates in the order defined by the quantum circuit to generate a quantum circuit cost function output. For example, some embodiments may provide a determined quantum circuit with a first, second, and third state value. The determined quantum circuit may include a first layer of quantum logic gates to perform a first set of rotations about a first axis with respect to a corresponding set of rotation parameters. The determined quantum circuit may also include a second layer of quantum logic gates to perform a second set of rotations about a second axis with respect to respective rotation parameters. Some embodiments may then execute the determined quantum circuit by performing the first set of rotations based on the first, second, and third state values and then performing the second set of rotations based on the outputs of the first set of rotations. For example, some embodiments may perform the first set of rotations based on a vector that includes the first, second, and third state values to generate a first rotated vector and then perform the second set of rotations on the first rotated to obtain a second rotated vector.

Some embodiments may obtain a pre-determined initial guess state to provide as the input to a quantum circuit. For example, some embodiments may set each respective state value of a pre-determined initial guess state to zero or otherwise set an initial guess state such that a first state value of the initial guess state is equal to a second state value of the initial guess state. For example, some embodiments may set each respective state value of a pre-determined initial guess state to “1.0.” Alternatively, some embodiments may determine an initial guess state based on a set of limitations associated with a cost function. For example, some embodiments may use a non-quantum neural network, another type of machine learning method, or a statistical method to predict an initial guess state that is then provided to a quantum computing circuit.

As described elsewhere in this disclosure, some embodiments may determine a gradient using a QNG descent method. For example, some embodiments may use a QNG descent method to determine a descent direction by first determining a set of Riemannian metrics based on an initial guess state and partial derivatives of the initial guess state with respect to a set of gate parameters. Some embodiments may determine a descent direction using the set of Riemannian metrics in the non-Euclidean distribution space of the gate parameters. Some embodiments may then update a gate parameter in the direction of the descent direction, where the magnitude of the increase or decrease to the gate parameter is correlated with a learning rate parameter.

While some embodiments may execute a quantum circuit for only one iteration before determining whether to update a learning rate parameter, some embodiments may execute the quantum circuit over multiple iterations before determining whether to update the learning rate parameter. Some embodiments may advance a state using a quantum neural network for a predetermined number of iterations before determining a quantum neural network output that is used to determine whether to update a learning rate parameter. For example, some embodiments may determine an output state by using a QNG method to advance the quantum state using a quantum circuit for one iteration, two iterations, more than two iterations, more than five iterations, more than 50 iterations, some other number of iterations, etc. Furthermore, some embodiments may continue to advance the state of a quantum computation until a set of termination criteria is satisfied.

Some embodiments may select, construct, or otherwise determine a quantum circuit acting as a quantum neural network. Various types of quantum neural networks may be used to determine a quantum circuit cost function output. Such types of quantum neural networks may include a quantum convolutional neural network, a quantum recurrent neural network, a quantum graph neural network, etc. For example, some embodiments may select a quantum convolutional neural network that includes a quantum convolution layer, a quantum pooling layer, and a quantum neural network layer.

Some embodiments may determine whether a set of termination criteria is satisfied, as indicated by block 320. In some embodiments, the set of termination criteria may include only one criterion. For example, some embodiments may determine that the set of termination criteria is satisfied based on a determination that an accuracy threshold between a cost function output and a quantum circuit cost function output is satisfied. Alternatively, some embodiments may determine that the set of termination criteria is satisfied based on a determination that an accuracy threshold between a first quantum circuit cost function output and a second quantum circuit cost function output is satisfied. Alternatively, or in addition, the set of termination criteria may include multiple criteria. For example, some embodiments may determine that the set of termination criteria is satisfied based on a determination that an accuracy threshold is satisfied and that an average difference in the last N outputs is less than a difference threshold. Furthermore, some embodiments may permit multiple possible sets of termination criteria. For example, some embodiments may determine that the set of termination criteria is satisfied if a count of the number of state advancing iterations that have been performed is greater than a first threshold (e.g., a predetermined maximum allowable count of iteration) or if a relative difference between a first quantum neural network output and second quantum neural network output satisfies a difference threshold. If a determination is made that the set of termination criteria is satisfied, operations of the process 300 may proceed to block 340. Otherwise, operations of the process 300 may proceed to block 324.

Some embodiments may determine a gradient based on the set of input parameters used to determine the first quantum circuit cost function output, as indicated by block 324. Some embodiments may first determine a transformed coordinate system for the gate parameter space of a quantum circuit. For example, some embodiments may implement a QNG model to determine a gradient. Implementing a QNG model includes determining a transformed gradient in the Euclidean space of a set of gate parameters. Some embodiments may determine the transformed gradient by determining a Fubini-Study metric to map the steepest descent in the Euclidean space to the steepest descent in the Riemannian space. Furthermore, some embodiments may use other methods to determine a gradient.

Some embodiments may use a method based on the parameter-shift rule to determine a gradient, where the method based on the parameter-shift rule may include operations such as evaluating a cost function at one or more shifted parameter positions. Some embodiments may implement different implementations of the parameter-shift rule based on a number of parameters. For example, a system may first provide a set of input parameters to a quantum circuit to determine a current quantum circuit output and then shift one or more values of the set of input parameters by π/2 or some other constant value to obtain a set of shifted input parameters. The system may then provide the set of shifted parameter inputs to the quantum circuit to generate an additional quantum circuit output and determine a gradient direction and associated gradient based on the current quantum circuit output and the additional quantum circuit output. For example, some embodiments may determine a gradient based on the difference between the first and additional quantum circuit output. Alternatively, or additionally, some embodiments may directly configure a quantum circuit to implement this set of operations to determine a gradient, where a system may include a first quantum circuit to determine a cost function output and a second quantum circuit to determine a gradient for a cost function.

As used in this disclosure, the Fubini-Study metric may be determined as an approximated Fubini-Study metric or a full Fubini-Study metric. Some embodiments may determine a Fubini-Study metric by determining the approximated Fubini-Study metric. When determining an approximated Fubini-Study metric, some embodiments may first determine sets of values representing diagonal submatrices based on a quantum circuit, where each respective submatrix may represent a respective layer of a quantum circuit. Determining a respective set of values representing a respective diagonal submatrix for a respective layer may include determining a respective quantum sub-circuit representing a set of quantum logic gates of prior layers for the respective layer. Some embodiments may then execute the respective diagonal submatrix based on a set of input parameters to obtain corresponding measurements for the respective diagonal submatrix. Some embodiments may determine the diagonal and off-diagonal terms for each respective block submatrix for the respective layers of the quantum circuit to obtain a full Fubini-Study metric. In some embodiments, the off-diagonal blocks in a full Fubini-Study metric may be computed with respect to parameters across the respective layers, in contrast to parameters within the respective layers.

Alternatively, some embodiments may determine a full Fubini-Study metric by using both diagonal and off-diagonal submatrices. Various methods may be used to determine a full Fubini-Study metric. For example, some embodiments may use the method described by Guo et al. (Guo, M., Hernandez, J., Myers, R. C. and Ruan, S. M., 2018. Circuit complexity for coherent states. Journal of High Energy Physics, 2018(10), pp. 1-60), the entirety of which is incorporated herein.

Some embodiments may implement a method based on a parameter-shift rule to determine the Fubini-Study metric when determining a gradient. For example, some embodiments may determine a set of metric values by implementing a set of parameter-shift rules for each diagonal and off-diagonal term of a Fubini-Study metric tensor. Furthermore, some embodiments may determine a gradient based on a Fubini-Study metric by determining an inversion of the Fubini-Study metric and setting the gradient to be a product of the Fubini-Study metric. For example, some apply the operations described by Equations E.1, E.2, and E.3 below, where “FullFubiniMetric” represents a function to determine a full Fubini-Study metric based on a set of input parameters θᵢ, “PseudoInvert” represents an inversion function that performs a pseudo-inversion operation based on the full Fubini-Study metric, and ∇_{Eucl}f(θᵢ) represents a gradient in Euclidean space of a function at the set of input parameters θᵢ. for the output of a quantum circuit or another function, and where some embodiments may use an approximated Fubini-Study Metric in place of a full Fubini-Study metric:

F(θᵢ)=FullFubiniMetric(θᵢ) (E.1)

F(θᵢ)⁻¹=PseudoInvert(F(θᵢ) (E.2)

∇_{f}(θᵢ)=F(θᵢ)⁻¹∇_{Eucl}f(θᵢ) (E.3)

While some embodiments may determine a gradient using a natural gradient method, some embodiments may instead use another type of descent method, such as a Euclidean gradient descent method in the gate parameter space of a set of operators. For example, some embodiments may use a quantum circuit configured with an initial set of parameters to determine a set of quantum circuit cost function outputs and determine a set of differentials in the parameter space of the initial set of parameters based on variations in the initial set of parameters. Some embodiments may then use the set of differentials and their associated changes in the output space of the quantum circuit to determine a set of first-order derivatives representing a gradient in the parameter space.

Some embodiments may determine a second quantum circuit cost function output based on the gradient, as indicated by block 326. After determining a gradient, some embodiments may determine a gradient-updated set of input parameters based on the gradient and then determine a second quantum circuit cost function output based on the gradient-updated set of input parameters. For example, some embodiments may determine an updated input based on Equations E.4 and E.5 shown below, where f may represent a cost function implemented in a quantum circuit, and where θᵢ may represent a first set of input parameters, and where ∇_{f}(θ) may represent a computed gradient, and where θ_{i,updated} may represent a gradient-updated set of input parameters, and where β may represent a constant value that indicates a pre-determined maximum step size value, and where λᵢ may represent a ratio indicating a step size, and where kᵢ may represent a step size parameter described elsewhere in this disclosure:

$${λ}_{i} = \frac{β}{{2}^{{k}_{i}}} \qquad ( E \text{.4} )$$

$${θ}_{i , updated} = {θ}_{i} - {λ}_{i} ∇ f ( {θ}_{i} ) \qquad ( E \text{.5} )$$

Some embodiments may determine whether a comparison value determined based on a learning rate parameter and the quantum circuit cost function outputs satisfies a threshold, as indicated by block 328. After determining a set of quantum circuit cost function outputs using operations described in this disclosure, some embodiments may use the set of quantum circuit cost function outputs or an associated computed gradient to determine a threshold used to determine whether a learning rate parameter should be updated. Alternatively, or additionally, some embodiments may use a set of quantum circuit cost function outputs or an associated computed gradient to determine whether a learning rate parameter satisfies the threshold.

Some embodiments may determine a comparison value based on a set of comparison component values and determine whether the comparison value satisfies the threshold, where the set of comparison component values may include a set of quantum circuit cost function outputs, a learning rate parameter, a predetermined scaling factor, etc. In some embodiments, a comparison value may satisfy a threshold if a function output for a function (e.g., a predicted difference function) using the set of comparison component values as inputs satisfies the threshold. Some embodiments use the Armijo's principle to determine whether to update a learning rate parameter based on the comparison component values. For example, some embodiments may determine whether a predicted difference between a first output and a second output satisfies a threshold. The first output may be determined by providing a quantum circuit with a first set of input parameters, and the second output may be determined by determining a gradient-updated set of input parameters based on the first set of input parameters and then providing the quantum circuit with the gradient-updated set of input parameters. For example, some embodiments may determine the predicted difference based on E.6 below, where Diff_{pred} represents a predicted difference between a first output f(θᵢ) and a second output f(θᵢ+λᵢ∇f(θᵢ)):

Diff_{pred}=f(θᵢ)−f(θᵢ−λᵢ∇f(θᵢ)) (E.6)

While the above describes using a predicted difference function, other types of functions are possible for use when comparing with a threshold associated with updating a learning rate parameter. For example, the function may be a product of all the set of comparison component values. Some embodiments may then determine that the set of comparison component values satisfies a threshold based on a determination that the product of the set of comparison component values is greater than the threshold.

Some embodiments may determine the threshold used to determine whether to update a learning rate parameter based on a computed gradient. Determining the threshold may include determining a geometric threshold based on the computed gradient. For example, some embodiments may implement a version of Armijo's principle to determine a threshold Thresh based on Equation E.7 below, where α may be a proportionality constant, and where λᵢ may remain an undetermined step size until a later operation:

Thresh=αλᵢ∥∇f(θᵢ)∥² (E.7)

It should be understood that, while a learning rate step size λ uses k and β as a learning rate parameter, some embodiments may use other values as learning rate parameters, where a learning rate step size may itself be a learning rate parameter. Some embodiments may use the predicted difference as a comparison value and compare the comparison with a computed threshold to determine whether or not to update a learning rate parameter. For example, some embodiments may implement a criterion represented by condition C.1, where some embodiments may determine k in such a way as to satisfy condition C.1:

$$f ( {θ}_{i} ) - f ( {θ}_{i} - \frac{β}{{2}^{k}} ∇ f ( {θ}_{i} ) ) \geq α \frac{β}{{2}^{k}} {‖ ∇ f ( {θ}_{i} ) ‖}^{2} \qquad ( C \text{.1} )$$

Some embodiments may then perform a line search operation to update a step size based on a condition. For example, some embodiments may determine the threshold based on an implementation of an Armijo condition, where the threshold may be based on the gradient of a cost function and a predicted difference between two quantum circuit cost function outputs satisfies a threshold. When implementing a condition, some embodiments may use an implementation of Condition C.1 over a series of sub-steps. For example, to determine a step size parameter k, some embodiments may repeatedly perform an inner loop that includes calculating a candidate k that satisfies the condition C.1 by iterating through an integer range from 0 to kₘ to determine a candidate k, where kₘ is a maximum number of steps to perform in a line search. During each iteration of the loop, some embodiments may determine a value for a candidate k that satisfies condition C.1 and store the candidate k in a set of candidate k values. Some embodiments may then determine a minimum k value from the set of candidate k values and use the minimum value as a final kᵢ value to determine a step size (e.g., by implementing Equation E.4 or Equation E.8 to determine the step size λᵢ). Furthermore, it should be understood that changing the definition of a learning rate step size λᵢ may result in alteration of condition C.1 to reflect the changed definition of the learning rate. For example, if λᵢ is defined as being equal to β^{k}, some embodiments may replace the term

$$\frac{β}{{2}^{k}}$$

in condition C.1 with β^{k}.

Furthermore, some embodiments may obtain a learning rate parameter as a default value. Alternatively, some embodiments may store one or more previously used learning rate parameters and then retrieve the previously used learning rate parameter when determining an initial learning rate parameter.

In some embodiments, if a comparison value determined based on a learning rate parameter does not satisfy the threshold, operations of the process 300 may proceed to operations described by block 332. For example, if a comparison value does not satisfy condition C.1, some embodiments may modify the value of the learning rate parameter used to determine the left-hand side of C.1 such that the comparison value does satisfy condition C.1, as described elsewhere in this disclosure. As used in this disclosure, a learning rate parameter may satisfy a threshold if a comparison value determined based on the learning rate parameter satisfies the threshold. In some embodiments, if a comparison value does satisfy the threshold, operations of the process 300 may proceed to operations described by block 330. For example, if the condition C.1 is satisfied, some embodiments may leave the learning rate parameter unchanged and update parameters of a quantum circuit based on the unchanged learning rate parameter.

While some embodiments may update a set of gate parameters without changing a learning rate parameter if the learning rate parameter does satisfy a set of criteria based on the predicted difference and the gradient, some embodiments may update the learning rate parameter even if the learning rate parameter satisfies the set of criteria. Some embodiments may update a learning rate step size by increasing the learning rate step size based on a determination that the learning rate step size already satisfies a line search threshold. For example, some embodiments may determine that a threshold is satisfied by a learning rate step size a. In response to a determination that the learning rate step size α satisfies the line search threshold, some embodiments may increase the value of the learning rate α. For example, some embodiments may increase the value of the learning rate step size α by a pre-set learning rate parameter increase ratio. Some embodiments may then re-compute whether the updated learning rate parameter continues to satisfy the predicted difference. In response to a determination that the updated learning rate parameter continues to satisfy the predicted difference, some embodiments may proceed to operations described by block 330.

Some embodiments may update a learning rate step size based on the predicted difference using a search method, as indicated by block 332. For example, some embodiments may determine a learning rate step size λᵢ for an i-th iteration based on a corresponding learning rate parameter k and a proportionality constant β as indicated by Equation E.4. Furthermore, while some embodiments may use Equation E.4 to update a step size, other functions may be used to determine a step size. For example, some embodiments may determine a step size using Equation E.8 below, where the learning rate step size λᵢ is shown to be a power law output of the learning rate parameter kᵢ:

λᵢ=β^{k}^{ᵢ} (E.8)

Some embodiments may use a pre-established ratio or set of ratios to determine an updated learning rate step size or another learning rate parameter. For example, some embodiments may configure an updated learning rate parameter to be ½ of a previous learning rate parameter of a previous optimization operation. While some embodiments may use the ratio of ½, other ratios less than 1.0 may be used, such as ⅞, ¾, ⅝, ⅓, ¼, or some other ratio less than 1.0. After determining a candidate learning rate step size, some embodiments may recompute a comparison value based on the corresponding updated learning rate parameter and return to operations described by block 326 to determine whether the recomputed comparison value satisfies the threshold. If the candidate updated learning rate satisfies the threshold, some embodiments may then proceed to update the set of gate parameters as described by block 330 based on the updated learning rate.

Some embodiments may store an updated learning rate in a set of records storing a history of previous learning rate parameters. For example, some embodiments may update a learning rate parameter and then store the updated learning rate parameter in a list of values representing a history of previous learning rate parameters. Some embodiments may then use the history of previous learning rate parameters to predict a future learning rate. For example, some embodiments may obtain a record of previous learning rate parameters and optimize a machine learning model to predict future learning rate parameters. Some embodiments may then use an optimized machine learning model to predict future learning rate parameters based on a current learning rate parameter. For example, some embodiments may optimize a neural network to predict a learning rate parameter based on a history of previous learning rate parameters. During a future optimization operation, some embodiments may then determine an updated learning rate by providing a set of previous learning rate parameters to the optimized neural network.

In order to preserve quantum computing resources, some embodiments may use a classical processor to determine and update a learning rate. Thus, for an optimization operation, some embodiments may execute an iteration of a quantum circuit using a set of quantum processors to determine a set of quantum circuit cost function outputs. Some embodiments may then use a set of classical processors in communication with the set of quantum processors to perform operations such as determining a natural gradient, determining whether a current learning rate parameter satisfies a threshold, or updating a threshold.

Some embodiments may update a set of gate parameters based on the learning rate step size, as indicated by block 330. Updating a gate parameter may include increasing or decreasing gate parameters by an amount correlated with a learning rate step size. For example, some embodiments may determine a next set of input parameters θᵢ₊₁ for a next iteration i+1 as indicated by Equation E.9, where the set of input parameters θᵢ for the i-th iteration used to configure a cost function, λᵢ represents a learning rate step size, and ∇_{f}(θᵢ) represents a cost function gradient of the i-th iteration:

θᵢ₊₁=θᵢ−λᵢ∇f(θᵢ) (E.9)

For example, if a gradient in a three-dimensional parameter space may be represented as [0.577, 0.577, 0.577], and if a corresponding learning rate step size λᵢ is equal to 0.75, some embodiments may approximate a corresponding gate parameter update vector for the three-dimensional parameter space as [0.433, 0.433, 0.433] by multiplying the gradient by the learning rate step size. Some embodiments may then modify the value of each gate parameter of a set of input parameters by 0.433. After updating the gate parameters, some embodiments may then configure a quantum circuit with the updated gate parameters and execute the updated quantum circuit. For example, some embodiments may return to performing operations described by block 308 when executing the updated quantum circuit.

Some embodiments may provide the set of quantum circuit outputs to the classical computing system, as indicated by block 340. The set of quantum circuit outputs may include a plurality of outputs, where each output may represent a different set of executions of a quantum circuit based on the same set of input parameters. The set of quantum circuit outputs may include quantum circuit cost function outputs, computed parameters, etc. Some embodiments may then perform one or more transformation operations based on the set of quantum circuit outputs to determine a set of values. Some embodiments may display the output of the quantum circuit on a graphical user interface, store the quantum circuit output in a database, communicate the quantum circuit output to another computing system, etc. For example, some embodiments may use a quantum circuit to perform combinatorial optimization to determine an optimal selection of items, determine a molecular configuration or other types of physical states, etc.

Some embodiments may then perform additional machine learning operations using a classical processor based on the set of quantum circuit outputs. For example, some embodiments use the set of quantum circuit cost function outputs as intermediate results that are then provided as inputs to a classical neural network, where the classical neural network is a neural network that is executed on a set of classical processors. Some embodiments may then display the output of the classical neural network on a graphical user interface, store the output in a database, communicate the output to another computing system, etc.

It should be noted that the features and limitations described in any one embodiment may be applied to any other embodiment herein, and a flowchart or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

In some embodiments, the various computer systems and subsystems illustrated in FIG. 1, FIG. 2, or otherwise disclosed in this disclosure may include one or more computing devices that are programmed to perform the functions described herein. The computing devices may include one or more electronic storages (e.g., the memory 148), one or more physical processors programmed with one or more computer program instructions, and/or other components. For example, the memory 148 may store databases, arrays, objects, or other types of data structures that include inputs, gate parameters, or quantum circuit outputs described in this disclosure.

The computing devices may include communication lines or ports to enable the exchange of information with a set of networks or other computing platforms via wired or wireless techniques. The network may include the Internet, a mobile phone network, a mobile voice or data network (e.g., a 5G or LTE network), a cable network, a public switched telephone network, or other types of communications networks or combinations of communications networks. The network may include one or more communications paths, such as Ethernet, a satellite path, a fiber-optic path, a cable path, a path that supports Internet communications (e.g., IPTV), free-space connections (e.g., for broadcast or other wireless signals), WiFi, Bluetooth, near field communication, or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

The computing devices described in this disclosure may include electronic storages, such as the memory 148. The electronic storages may include non-transitory storage media that electronically stores information. The storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). An electronic storage may store software algorithms, information determined by the processors, information obtained from servers, information obtained from client devices, or other information that enables the functionality as described herein.

A computing system that includes a set of processors may be programmed to provide information processing capabilities in the computing devices. As such, the set of processors may include one or more of a digital processor, an analog processor, a digital circuit designed to process information, an analog circuit designed to process information, a state machine, and/or other mechanisms for electronically processing information. In some embodiments, the set of processors may include a plurality of processing units, where at least one processor of the plurality of processing units is a classical processor and another processor of the plurality of processing units is a quantum computing device. As used in this disclosure, the term “classical processor” may include various types of digital processors, such as a set of general-purpose microprocessors that can execute computer program code. The term “classical computing system” may include any computer system that uses the classical processor to performs computing operations. These processing units may be physically located within the same device, or the processors may represent processing functionality of a plurality of devices operating in coordination. The processors may be programmed to execute computer program instructions to perform functions described herein, such as program instructions to perform one or more operations of the process 300. The processors may be programmed to execute computer program instructions by software, hardware, firmware, some combination of software, hardware, or firmware, or other mechanisms for configuring processing capabilities on the processors.

It should be appreciated that the description of the functionality provided by the different subsystems described herein is for illustrative purposes, and is not intended to be limiting, as any of subsystems may provide more or less functionality than is described. For example, one or more of subsystems may be eliminated, and some or all of its functionality may be provided by other ones of subsystems. As another example, additional subsystems may be programmed to perform some or all of the functionality attributed herein to one of subsystems.

With respect to the components of computing devices described in this disclosure, each of these devices may receive content and data via an I/O system, such as the I/O subsystem 144. Each of these devices may also include processors and/or control circuitry to send and receive commands, requests, and other suitable data using the I/O subsystem. The control circuitry may comprise any suitable processing, storage, and/or input/output circuitry. Further, some or all of the computing devices described in this disclosure may include a user input interface and/or user output interface (e.g., a display) for use in receiving and displaying data. For example, input device connected to an I/O system may include a display screen, mouse, a touchpad, a microphone, a keyboard, a camera, etc. It should be noted that in some embodiments, one or more devices described in this disclosure may have neither user input interface nor displays and may instead receive and display content using another device (e.g., a dedicated display device such as a computer screen and/or a dedicated input device such as a remote control, mouse, voice input, etc.). Additionally, one or more of the devices described in this disclosure may run an application (or another suitable program) that performs one or more operations described in this disclosure.

In some embodiments, the components of a computing system may communicate with each other via a system interconnect, such as the system interconnect 130. The system interconnect may include a set of separate physical buses, point to point connections, bridges, adapters, or controllers. For example, the system interconnect 130 may include a system bus, a Peripheral Component Interconnect (PCI) bus or PCI-Express bus, a HyperTransport or industry standard architecture (ISA) bus, a small computer system interface (SCSI) bus, a universal serial bus (USB), an IIC (I2C) bus, or an Institute of Electrical and Electronics Engineers (IEEE) standard 1394 bus, etc.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the context clearly indicates otherwise. Thus, for example, reference to “an element” or “a element” includes a combination of two or more elements, notwithstanding use of other terms and phrases for one or more elements, such as “one or more.” The term “or” is non-exclusive (i.e., encompassing both “and” and “or”), unless the context clearly indicates otherwise. Terms describing conditional relationships (e.g., “in response to X, Y,” “upon X, Y,” “if X, Y,” “when X, Y,” and the like) encompass causal relationships in which the antecedent is a necessary causal condition, the antecedent is a sufficient causal condition, or the antecedent is a contributory causal condition of the consequent (e.g., “state X occurs upon condition Y obtaining” is generic to “X occurs solely upon Y” and “X occurs upon Y and Z”). Such conditional relationships are not limited to consequences that instantly follow the antecedent obtaining, as some consequences may be delayed, and in conditional statements, antecedents are connected to their consequents (e.g., the antecedent is relevant to the likelihood of the consequent occurring). Statements in which a plurality of attributes or functions are mapped to a plurality of objects (e.g., one or more processors performing steps/operations A, B, C, and D) encompasses both all such attributes or functions being mapped to all such objects and subsets of the attributes or functions being mapped to subsets of the attributes or functions (e.g., both all processors each performing steps/operations A-D, and a case in which processor 1 performs step/operation A, processor 2 performs step/operation B and part of step/operation C, and processor 3 performs part of step/operation C and step/operation D), unless otherwise indicated. Further, unless otherwise indicated, statements that one value or action is “based on” another condition or value encompass both instances in which the condition or value is the sole factor and instances in which the condition or value is one factor among a plurality of factors. For example, updating a first value based on a second value may include updating the first value based only on the second value or updating the first value based on both the second value and a third value.

Unless the context clearly indicates otherwise, statements that “each” instance of some collection have some property should not be read to exclude cases where some otherwise identical or similar members of a larger collection do not have the property (i.e., each does not necessarily mean each and every). Limitations as to sequence of recited steps should not be read into the claims unless explicitly specified (e.g., with explicit language like “after performing X, performing Y”) in contrast to statements that might be improperly argued to imply sequence limitations, (e.g., “performing X on items, performing Y on the X'ed items”) used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless the context clearly indicates otherwise, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Furthermore, indicated otherwise, updating an item may include generating the item or modifying an existing time. Thus, updating a record may include generating a record or modifying the value of already-generated value. Additionally, as used in the specification, “a portion,” refers to a part of, or the entirety of (i.e., the entire portion), a given item (e.g., data) unless the context clearly dictates otherwise. Furthermore, a “set” may refer to a singular form or a plural form, such as that a “set of items” may refer to one item or a plurality of items.

The present techniques will be better understood with reference to the following enumerated embodiments:
1. A method storing instructions that, when executed by one or more processors, effectuate method comprising: executing a quantum circuit comprising a plurality of quantum logic gates to determine a first quantum circuit output based on a set of input parameters; determining a gradient based on the set of input parameters; providing the quantum circuit with an updated set of input parameters to determine a second quantum circuit output, the gradient and the set of input parameters; determining a comparison value based on the first quantum circuit output and the second quantum circuit output; updating the learning rate parameter such that the comparison value satisfies a threshold; and updating parameters of the plurality of quantum logic gates based on the updated learning rate parameter.
2. The method of embodiment 1, wherein the updated set of input parameters is determined based on a learning rate parameter.
3. A method comprising: determining a quantum circuit comprising a plurality of quantum logic gates implementing a corresponding plurality of unitary operators; executing the quantum circuit using the quantum processor to determine a current quantum circuit cost function output based on a set of input parameters; updating a learning rate by: determining a gradient based on the current quantum circuit cost function output; determining a gradient-updated set of input parameters based on the gradient and the set of input parameters; computing an additional quantum circuit cost function output by providing the quantum circuit with the gradient-updated set of input parameters; determining a comparison value based on a learning rate hyperparameter, the current quantum circuit cost function output, and the additional quantum circuit cost function output; determining a threshold based on the gradient; determining whether the comparison value satisfies the threshold; and in response to a determination that the comparison value does not satisfy the threshold, updating the learning rate hyperparameter and a learning rate step size associated with the learning rate hyperparameter such that the comparison value satisfies the threshold; and updating the set of input parameters based on the updated learning rate step size.
4. A method comprising: determining a quantum circuit comprising a plurality of quantum logic gates; executing the quantum circuit to determine a first quantum circuit cost function output based on a set of input parameters; updating a learning rate parameter by: determining a gradient based on the set of input parameters; computing a second quantum circuit cost function output by providing the quantum circuit with an updated set of input parameters, wherein the updated set of input parameters is updated based on the gradient and a learning rate parameter; determining a comparison value based on the first quantum circuit cost function output and the second quantum circuit cost function output; in response to a determination that the comparison value does not satisfy a threshold, updating the learning rate parameter such that the comparison value satisfies the threshold, wherein the threshold is determined based on the gradient; and updating parameters of the plurality of quantum logic gates based on the updated learning rate parameter.
5. The method of any of embodiments 1 to 4, wherein determining the gradient comprises: determining a set of shifted input parameters by adding a constant value to a parameter of the set of input parameters; and determining the gradient based on the set of shifted input parameters.
6. The method of any of embodiments 1 to 5, wherein determining the threshold comprises determining a power law output based on the gradient; and determining whether the comparison value satisfies the threshold comprises determining whether the comparison value is less than the threshold.
7. The method of any of embodiments 1 to 6, wherein the learning rate hyperparameter is a current learning rate hyperparameter, the method comprising: obtaining a history of previous learning rate hyperparameters; and predicting the current learning rate hyperparameter based on the history of previous learning rate parameters.
8. The method of embodiment 7, wherein predicting the current learning rate hyperparameter comprises executing a neural network on a classical processor to obtain the current learning rate hyperparameter based on the history of previous learning rate hyperparameters.
9. The method of any of embodiments 1 to 8, wherein updating the set of input parameters comprises: determining a product based on the learning rate parameter and the gradient; and updating the set of input parameters based on the product.
10. The method of any of embodiments 1 to 9, wherein executing the quantum circuit comprises providing the quantum circuit with a first set of input parameters to obtain the first quantum circuit cost function output, and wherein determining the gradient comprises: determining a set of differentials in a parameter space of the parameters; and determining the gradient based on the set of differentials.
11. The method of any of embodiments 1 to 10, wherein executing the quantum circuit comprises executing the quantum circuit using a quantum processor.
12. The method of any of embodiments 1 to 11, wherein determining the gradient comprises determining diagonal terms and off-diagonal terms of a Fubini-Study metric tensor.
13. The method of any of embodiments 1 to 12, wherein the quantum circuit is a first quantum circuit, and wherein determining the gradient comprises executing a second quantum circuit to determine the gradient, and wherein the first quantum circuit may be executed independently of the second quantum circuit.
14. The method of any of embodiments 1 to 13, wherein: the quantum circuit comprises a first layer and a second layer in a sequence; and executing the quantum circuit comprises providing, as an input to the second layer, an output of the first layer.
15. The method of any of embodiments 1 to 14, wherein the plurality of quantum logic gates comprises a rotation operator.
16. The method of any of embodiments 1 to 15, wherein determining the comparison value comprises determining a difference between the first quantum circuit cost function output and the second quantum circuit cost function output.
17. The method of any of embodiments 1 to 16, wherein the quantum circuit comprises at least one of a rotation operator, a controlled NOT gate, and a phase shift gate.
18. The method of any of embodiments 1 to 17, wherein the quantum circuit is configured based on an unconstrained binary optimization function.
19. The method of any of embodiments 1 to 18, further comprising: retrieving a previous learning rate parameter of a previous optimization operation associated with the quantum circuit; and setting the learning rate parameter to be equal to the previous learning rate parameter.
20. The method of any of embodiments 1 to 19, the method further comprising: determining that the comparison value satisfies the threshold; and in response to determining that the comparison value satisfies the threshold, increasing the learning rate parameter, wherein increasing the learning rate parameter updates the comparison value, and wherein the updated comparison value satisfies the threshold.
21. The method of any of embodiments 1 to 20, wherein: executing the quantum circuit comprises executing the quantum circuit using a quantum processor; and updating the learning rate parameter comprises updating the learning rate parameter using a classical processor.
22. One or more tangible, non-transitory, machine-readable media storing instructions that, when executed by one or more processors, effectuate operations comprising those of any of embodiments 1-21.
23. A system comprising: one or more processors; and memory storing computer program instructions that, when executed by the one or more processors, cause the one or more processors to effectuate operations comprising those of any of embodiments 1-21.

What is claimed is:

1. A system for adaptively updating a learning rate to increase a rate of convergence comprising:
a set of processors comprising a quantum processor; and
memory storing computer program instructions that, when executed by the set of processors, cause the set of processors to effectuate operations comprising:
determining a quantum circuit comprising a plurality of quantum logic gates implementing a corresponding plurality of unitary operators;
executing the quantum circuit using the quantum processor to determine a current quantum circuit cost function output based on a set of input parameters;
updating a learning rate by:
determining a gradient based on the current quantum circuit cost function output;
determining a gradient-updated set of input parameters based on the gradient and the set of input parameters;
computing an additional quantum circuit cost function output by providing the quantum circuit with the gradient-updated set of input parameters;
determining a comparison value based on a learning rate hyperparameter, the current quantum circuit cost function output, and the additional quantum circuit cost function output;
determining a threshold based on the gradient;
determining whether the comparison value satisfies the threshold; and
in response to a determination that the comparison value does not satisfy the threshold, updating the learning rate hyperparameter and a learning rate step size associated with the learning rate hyperparameter such that the comparison value satisfies the threshold; and
updating the set of input parameters based on the updated learning rate step size.

2. The system of claim 1, wherein determining the gradient comprises:
determining a set of shifted input parameters by adding a constant value to a parameter of the set of input parameters; and
determining the gradient based on the set of shifted input parameters.

3. The system of claim 1, wherein determining the threshold comprises determining a power law output based on the gradient; and
determining whether the comparison value satisfies the threshold comprises determining whether the comparison value is less than the threshold.

4. The system of claim 1, wherein the learning rate hyperparameter is a current learning rate hyperparameter, the operations comprising:
obtaining a history of previous learning rate hyperparameters; and
predicting the current learning rate hyperparameter based on the history of previous learning rate parameters.

5. The system of claim 4, wherein predicting the current learning rate hyperparameter comprises executing a neural network on a classical processor to obtain the current learning rate hyperparameter based on the history of previous learning rate hyperparameters.

6. A method comprising:
determining a quantum circuit comprising a plurality of quantum logic gates;
executing the quantum circuit to determine a first quantum circuit cost function output based on a set of input parameters;
updating a learning rate parameter by:
determining a gradient based on the set of input parameters;
computing a second quantum circuit cost function output by providing the quantum circuit with an updated set of input parameters, wherein the updated set of input parameters is updated based on the gradient and a learning rate parameter;
determining a comparison value based on the first quantum circuit cost function output and the second quantum circuit cost function output;
in response to a determination that the comparison value does not satisfy a threshold, updating the learning rate parameter such that the comparison value satisfies the threshold, wherein the threshold is determined based on the gradient; and
updating parameters of the plurality of quantum logic gates based on the updated learning rate parameter.

7. The method of claim 6, wherein updating the set of input parameters comprises:
determining a product based on the learning rate parameter and the gradient; and
updating the set of input parameters based on the product.

8. The method of claim 6, wherein executing the quantum circuit comprises providing the quantum circuit with a first set of input parameters to obtain the first quantum circuit cost function output, and wherein determining the gradient comprises:
determining a set of differentials in a parameter space of the parameters; and
determining the gradient based on the set of differentials.

9. The method of claim 6, wherein executing the quantum circuit comprises executing the quantum circuit using a quantum processor.

10. The method of claim 6, wherein determining the gradient comprises determining diagonal terms and off-diagonal terms of a Fubini-Study metric tensor.

11. The method of claim 6, wherein the quantum circuit is a first quantum circuit, and wherein determining the gradient comprises executing a second quantum circuit to determine the gradient, and wherein the first quantum circuit may be executed independently of the second quantum circuit.

12. The method of claim 6, wherein:
the quantum circuit comprises a first layer and a second layer in a sequence; and
executing the quantum circuit comprises providing, as an input to the second layer, an output of the first layer.

13. The method of claim 6, wherein the plurality of quantum logic gates comprises a rotation operator.

14. The method of claim 6, wherein determining the comparison value comprises determining a difference between the first quantum circuit cost function output and the second quantum circuit cost function output.

15. One or more tangible, non-transitory, machine-readable media storing instructions that, when executed by one or more processors, effectuate operations comprising:
executing a quantum circuit comprising a plurality of quantum logic gates to determine a first quantum circuit output based on a set of input parameters;
determining a gradient based on the set of input parameters;
providing the quantum circuit with an updated set of input parameters to determine a second quantum circuit output, wherein the updated set of input parameters is determined based on a learning rate parameter, the gradient and the set of input parameters;
determining a comparison value based on the first quantum circuit output and the second quantum circuit output;
updating the learning rate parameter such that the comparison value satisfies a threshold; and
updating parameters of the plurality of quantum logic gates based on the updated learning rate parameter.

16. The one or more tangible, non-transitory, machine-readable media of claim 15, wherein the quantum circuit comprises at least one of a rotation operator, a controlled NOT gate, and a phase shift gate.

17. The one or more tangible, non-transitory, machine-readable media of claim 15, wherein the quantum circuit is configured based on an unconstrained binary optimization function.

18. The one or more tangible, non-transitory, machine-readable media of claim 15, further comprising:
retrieving a previous learning rate parameter of a previous optimization operation associated with the quantum circuit; and
setting the learning rate parameter to be equal to the previous learning rate parameter.

19. The one or more tangible, non-transitory, machine-readable media of claim 15, the operations further comprising:
determining that the comparison value satisfies the threshold; and
in response to determining that the comparison value satisfies the threshold, increasing the learning rate parameter, wherein increasing the learning rate parameter updates the comparison value, and wherein the updated comparison value satisfies the threshold.

20. The one or more tangible, non-transitory, machine-readable media of claim 15, wherein:
executing the quantum circuit comprises executing the quantum circuit using a quantum processor; and
updating the learning rate parameter comprises updating the learning rate parameter using a classical processor.
